(19) United States
(12) Patent Application Publication
(10) Pub. No.: US 2025/0376026 A1
(43) Pub. Date: Dec. 11, 2025

(54) PROJECTION MODULE USED IN VEHICLE

(71) Applicant: CARUX TECHNOLOGY PTE. LTD., SINGAPORE (SG)

(72) Inventors: Ta-Chin Huang, Tainan (TW); Yu-Chien Kao, Tainan (TW); Ching-I Lo, Tainan (TW)

(73) Assignee: CARUX TECHNOLOGY PTE. LTD., SINGAPORE (SG)

(21) Appl. No.: 19/201,958

(22) Filed: May 8, 2025

(30) Foreign Application Priority Data
Jun. 6, 2024 (CN) 202410731755.2

(51) Int. Cl. B60K 35/22; B60K 35/55; B60K 35/60; B60K 35/65

(52) U.S. Cl. CPC B60K 35/22; B60K 35/55; B60K 35/60; B60K 35/656; B60K 2360/23; B60K 2360/27; B60K 2360/77

(57) ABSTRACT

The disclosure provides a projection module used in a vehicle. The projection module includes a partition and a projection device. The partition is disposed between a front seat and a rear seat of the vehicle and includes a substrate and an optical film disposed on the substrate. The optical film has a reflection axial direction and a transmission axial direction. The incident light has a first reflectivity and a first transmittance in the reflection axial direction, and a second reflectivity and a second transmittance in the transmission axial direction. The projection device is used to project a display light beam to the optical film of the partition. The first reflectivity is greater than the second reflectivity. The first reflectivity is between 20% and 100%. The first transmittance is between 0% to 80%. The second reflectivity is between 0% and 40%. The second transmittance is between 60% to 100%.

### CROSS-REFERENCE TO RELATED APPLICATION

This application claims the priority benefit of China application serial no. 202410731755.2, filed on Jun. 6, 2024. The entirety of the above-mentioned patent application is hereby incorporated by reference herein and made a part of this specification.

### BACKGROUND

### Technical Field

The disclosure relates to a projection module, and particularly relates to a projection module used in a vehicle.

### Description of Related Art

The vehicle projection module can project the display image on the rear seat projection screen to facilitate viewing by rear seat passengers. However, there are still many problems that need to be improved in the current vehicle projection module, such as poor viewing experience due to factors such as insufficient image brightness, ambient light interference, and/or projection screen shaking.

### SUMMARY

The disclosure provides a projection module used in a vehicle, which helps to improve the viewing experience.

According to an embodiment of the disclosure, a projection module used in a vehicle includes a partition and a projection device. The partition is disposed between a front seat and a rear seat of the vehicle and includes a substrate and an optical film disposed on the substrate. The optical film has a reflection axial direction and a transmission axial direction. The incident light has a first reflectivity and a first transmittance in the reflection axial direction, and the incident light has a second reflectivity and a second transmittance in the transmission axial direction. The projection device is used to project a display light beam to the optical film of the partition. The first reflectivity is greater than the second reflectivity. The first reflectivity is between 20% and 100%. The first transmittance is between 0% to 80%. The second reflectivity is between 0% and 40%. The second transmittance is between 60% to 100%.

In order to make the above-mentioned features and advantages of the disclosure clearer and easier to understand, the following embodiments are given and described in details with accompanying drawings as follows.

### BRIEF DESCRIPTION OF THE DRAWINGS

FIG. 1 is a partial schematic cross-sectional view of a projection module used in a vehicle according to an embodiment of the disclosure;

FIG. 2 is an enlarged schematic view of an internal structure of the vehicle of FIG. 1;

FIG. 3 is a schematic view illustrating an optical principle of the partition of FIG. 1;

FIG. 4 is a partial schematic cross-sectional view of a projection module used in a vehicle according to another embodiment of the disclosure;

FIG. 5 is an enlarged schematic view of an internal structure of the vehicle of FIG. 4;

FIG. 6 is a partial schematic cross-sectional view of a projection module used in a vehicle according to still another embodiment of the disclosure;

FIG. 7A and FIG. 7B are schematic views of the fixing module and the partition of FIG. 6, respectively illustrating positions of the partition in a storage state and a use state.

### DESCRIPTION OF THE EMBODIMENTS

Reference will now be made in detail to the present preferred embodiments of the disclosure, examples of which are illustrated in the accompanying drawings. Whenever possible, the same reference numbers are used in the drawings and description to refer to the same or like parts.

Throughout the specification and the appended claims of the disclosure, certain words are used to refer to specific elements. Persons skilled in the art should understand that electronic device manufacturers may refer to the same elements by different names. The disclosure does not intend to distinguish the elements with the same function but different names. In the following specification and claims, words such as “containing” and “comprising” are open-ended words, which should be interpreted as “including but not limited to . . . ”.

In the present specification, wordings used to indicate direction, such as: “up”, “down”, “front”, “back”, “left”, “right”, merely refer to directions in the drawings. Therefore, the directional terms used are used to illustrate and are not intended to limit the disclosure. In the drawings, the figures depict the typical features of methods, structures, and/or materials used in the particular embodiments. However, the figures are not to be interpreted as defining or limiting the scope or nature of the embodiments. For example, the relative size, thickness, and location of various layers, regions, and/or structures may be reduced or enlarged for clarity.

When a structure (or layer, element, substrate) described in the disclosure as being located on/above another structure (or layer, element, substrate), it may mean that the two structures are adjacent and directly connected or it may mean that the two structures are adjacent but not directly connected. Indirect connection means that there is at least one intermediate structure (or intermediate layer, intermediate element, intermediate substrate, intermediate spacing) between the two structures, wherein the lower surface of one structure is adjacent to or directly connected to the upper surface of the intermediate structure, and the upper surface of the other structure is adjacent to or directly connected to the lower surface of the intermediate structure. The intermediate structure may be composed of a single-layer or multi-layer physical structure or non-physical structure, which is not limited. In the disclosure, when a certain structure is disposed “on” another structure, it may mean that the certain structure is “directly” on another structure or it may mean that the certain structure is “indirectly” on another structure, that is, at least one structure is also sandwiched between the certain structure and another structure.

The terms “about”, “substantially” or “roughly” are generally interpreted as within 10% of a given value or range or interpreted as within 5%, 3%, 2%, 1% or 0.5% of the given value or range. In addition, the phrases “a range is from a first value to a second value” and “the range is between a first value and a second value” mean that the given range includes the first value, the second value, and other values in between.

Terms such as “first” and “second” used in the description and claims are used to modify elements, and the terms do not imply and represent that the elements(s) have any previous ordinal numbers, nor do they represent the order of a certain element and another element or the order of a manufacturing method. The use of the ordinal numbers is only used to clearly distinguish between an element with a certain name and another element with the same name. The claims and the description may not use the same terms, whereby a first element in the specification may be a second element in the claims.

Electrical connection or coupling described in the disclosure may refer to direct connection or indirect connection. In the case of direct connection, terminals of elements on two circuits are directly connected or connected to each other by a conductor segment. In the case of indirect connection, there is a switch, a diode, a capacitor, an inductor, a resistor, other suitable elements, or a combination of the above elements between the terminals of the elements on the two circuits, but are not limited thereto.

In this disclosure, the measurement of thickness, length and width may be by adopting an optical microscope (OM), and the thickness or width may be measured by a cross-sectional image in an electron microscope, but not limited thereto. In addition, there may be a certain error in any two values or directions used for comparison. Additionally, the phrases “the given range is from a first value to a second value”, “the given range falls within the range of the first value to the second value”, or “the given range is between the first value and the second value” “mean that the given range includes the first value, the second value, and other values in between. If a first direction is perpendicular to a second direction, an angle between the first direction and the second direction may be between 80 degrees and 100 degrees; if the first direction is parallel to the second direction, the angle between the first direction and the second direction may be between 0 degrees and 10 degrees.

Unless otherwise defined, all terms (including technical and scientific terms) used herein have the same meaning as commonly understood by persons skilled in the art to which the disclosure belongs. It is understood that the terms, such as the terms defined in commonly used dictionaries, should be interpreted as having meanings consistent with the relevant art and the background or context of the disclosure, and should not be interpreted in an idealized or overly formal manner, unless otherwise defined in the embodiments of the disclosure.

In the disclosure, the electronic device may include a display device, a backlight device, an antenna device, a package device, a sensing device, or a splicing device, but the disclosure is not limited thereto. The electronic device may be a bendable or flexible electronic device. The display device may be a non-self-luminous display device or a self-luminous display device. The display device may include, for example, liquid crystal, light emitting diode, fluorescence, phosphor, quantum dot (QD), other suitable display media, or a combination of the above. The antenna device may, for example, include a reconfigurable intelligent surface (RIS), a frequency selective surface (FSS), a radio frequency filter (RF-Filter), a polarizer, a resonator, an antenna, etc. The antenna may be a liquid crystal antenna or a varactor diode antenna. The sensing device may be a sensing device that senses capacitance, light, heat, or ultrasonic waves, but the disclosure is not limited thereto. In the disclosure, the electronic device may include an electronic element, and the electronic element may include a passive element and an active element, such as a capacitor, a resistor, an inductor, a diode, a transistor, etc. The diode may include a light emitting diode, a varactor diode, or a photo diode. The light emitting diode may include, for example, an organic light emitting diode (OLED), a mini LED, a micro LED, or a quantum dot LED, but the disclosure is not limited thereto. The splicing device may be, for example, a display splicing device or an antenna splicing device, but the disclosure is not limited thereto. It should be noted that the electronic device may be any combination of the above, but the disclosure is not limited thereto. The package device may be adapted for wafer-level package (WLP) technology or panel-level package (PLP) technology, such as a package device using a chip first process or an RDL first process. In addition, the shape of the electronic device may be a rectangle, a circle, a polygon, a shape with curved edges, or other suitable shapes. The electronic device may have a peripheral system such as a driving system, a control system, a light source system, etc., to support a display device, an antenna device, a wearable device (e.g., including an augmented reality or a virtual reality), a vehicle-mounted device (e.g., including a car windshield), or a splicing device.

It should be noted that the technical solutions provided by the different embodiments hereinafter may be replaced, combined, and used in combination to constitute another embodiments without violating the spirit of the disclosure. Features in various embodiments may be mixed and matched as long as they do not violate the spirit of the disclosure or conflict with each other.

In embodiments of the disclosure, a projection module may be used in a vehicle 1. The type of the vehicle 1 is not limited. In terms of power, the vehicle 1 may be a gasoline vehicle (such as a gasoline vehicle or a diesel vehicle), a gasoline-electric hybrid vehicle, or an electric vehicle, but the disclosure is not limited thereto. The electric vehicle may have more accommodation space than the gasoline vehicle and the gasoline-electric hybrid vehicle. In terms of appearance or function, the vehicle may be a car, an SUV, a sports car, a truck, a bus, a military vehicle, a racing car, a special vehicle, an engineering vehicle, or a camper, but the disclosure is not limited thereto.

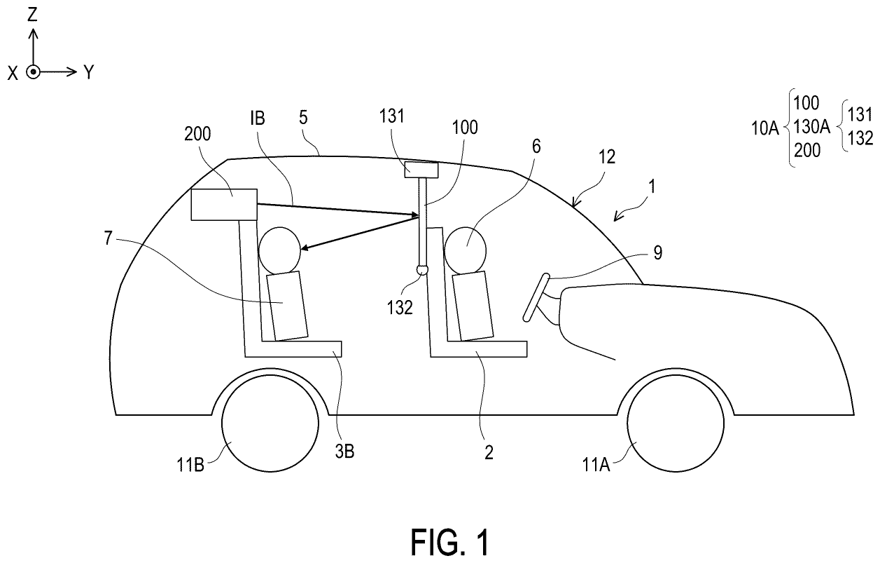

In FIG. 1 to FIG. 2 and FIG. 4 to FIG. 6, in order to clearly illustrate the installation position of the projection module, a driver 6, a passenger 7, a front seat 2 of the vehicle 1, a rear seat 3A and a rear seat 3B arranged side by side in a direction X, a vehicle pillar 4 located between the front seat 2 and the rear seats (including the rear seat 3A and the rear seat 3B), a vehicle roof located above the rear seats (including the rear seat 3A and the rear seat 3B), a control device 8, a steering wheel 9, a front wheel 11A, a rear wheel 11B, and a windshield 12 are shown. However, it should be understood that the type, appearance, interior decoration (including objects in the vehicle), etc., of the vehicle 1 may be changed according to requirements and are not limited to those shown in the drawings.

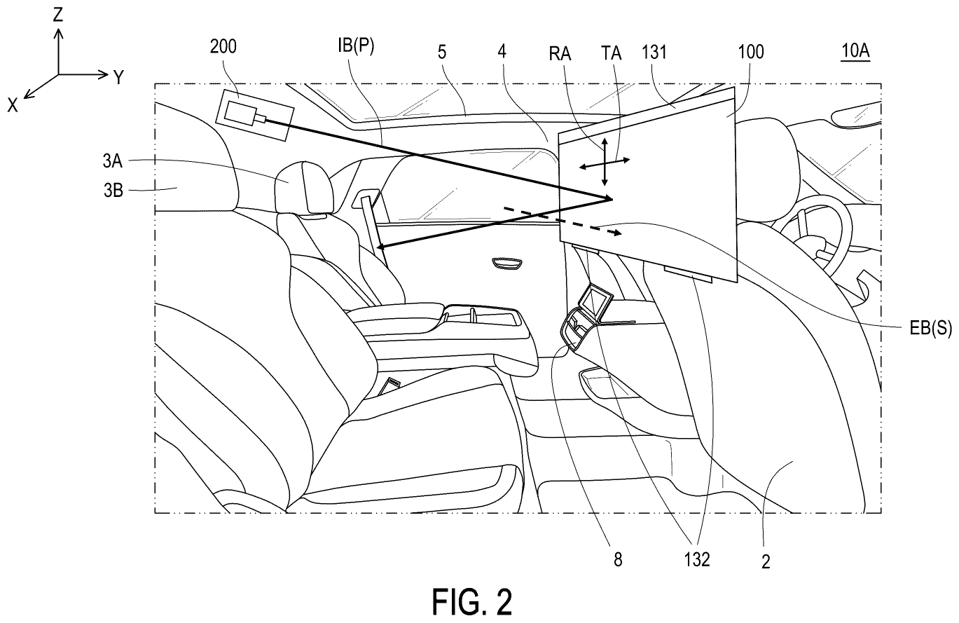

Referring to FIG. 1 and FIG. 2 at the same time, a projection module 10A may include a partition 100 and a display device 200, but the disclosure is not limited thereto. The projection module 10A can add or remove one or more elements according to requirements.

The partition 100 is disposed between the front seat 2 and the rear seats (including the rear seat 3A and the rear seat 3B). The projection device 200 is used to project a display light beam IB to the partition 100. For example, the projection device 200 includes a liquid crystal display, an LED display, a fluorescence display, a phosphor display, a digital light processing (DLP) projector, a liquid crystal on silicon (LCoS) display, a laser scanning system, or any combination of the above, but the disclosure is not limited thereto. The liquid crystal display may include a thin film transistor display, but is not limited thereto. The digital light processing projector may include a digital micromirror device (DMD) display or a zoom projector, but the disclosure is not limited thereto. The light emitting diode may include, for example, an organic light emitting diode (OLED), an inorganic light emitting diode, a mini LED, a micro LED, a quantum dot (QD) light-emitting diode (QLED, QDLED), or other suitable materials, or any combination of the above, but the disclosure is not limited thereto. In addition, the shape of the projection device 200 may be a rectangle, a circle, a polygon, a shape with curved edges, or other suitable shapes.

In some embodiments, as shown in FIG. 2, the projection device 200 and the rear seats (including the rear seat 3A and the rear seat 3B) may be located on a same side of the partition 100. For example, the projection device 200 may be located above the rear seat 3A and the rear seat 3B, and the projection device 200 may be disposed between the vehicle roof 5 and the rear seat 3A (or the rear seat 3B) in a direction Z, but the disclosure is not limited thereto.

In some embodiments, the vehicle 1 may include the control device 8, and the control device 8 may be electrically connected to the projection device 200 in a wired or wireless manner, so that the passenger 7 can select the display information projected by the projection device 200 by operating the control device 8 (such as a vehicle computer or a personal mobile device). Alternatively, the driver 6 may operate the center console to control the display information projected by the projection device 200.

Taking FIG. 2 as an example, the partition 100 may be parallel to a plane formed by the direction X and the direction Z, and the display light beam IB from the projection device 200 may be transmitted to the eyes of the passenger 7 through the reflection of the partition 100, so that the passenger 7 may see an enlarged real image corresponding to the displayed information in front of him.

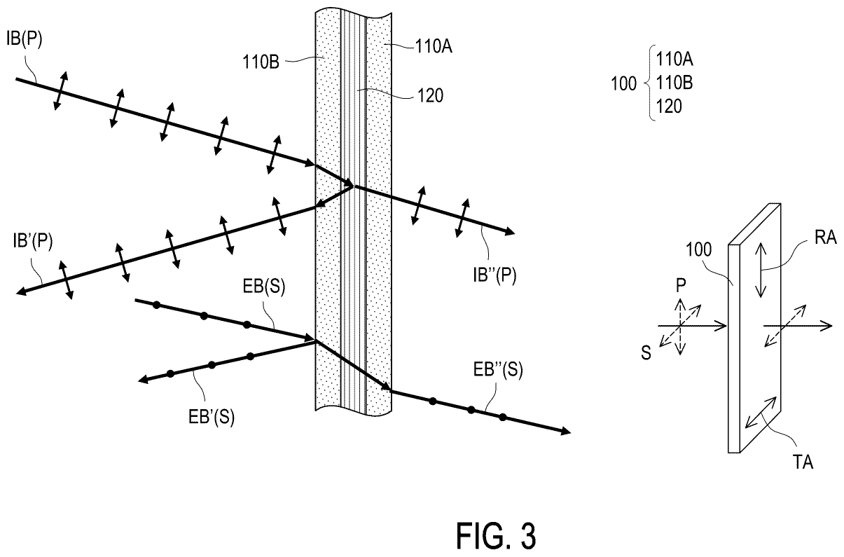

Continuing to refer to FIG. 3, the partition 100 may include a substrate 110A and an optical film 120 disposed on the substrate 110A. The optical film 120 may be coated or attached onto the substrate 110A. For example, the optical film 120 may be formed by coating on a side of the substrate 110A that is irradiated by the display light beam IB (hereinafter referred to as a light-facing side), or may be attached in the form of a sheet onto the light-facing side of the substrate 110A, but the disclosure is not limited thereto. In some embodiments, as shown in FIG. 3, the partition 100 may further include another substrate 110B, and the optical film 120 may be located between the substrate 110A and the substrate 110B. In some embodiments, two opposite sides of the optical film 120 may contact the substrate 110A and the substrate 110B respectively, but the disclosure is not limited thereto. In other embodiments, although not shown, the amount of the substrate in the partition 100 may be only one. For example, the substrate 110B may be omitted. Under this structure, a protective layer (not shown) may be selectively disposed on a surface of the optical film 120 away from the substrate 110A. The material of the protective layer is, for example, a polymer with high light transmittance (such as polycarbonate (PC), polyimide (PI), polypropylene (PP), polyethylene terephthalate (PET), etc.). In other words, the two opposite sides of the optical film 120 may contact the substrate 110A and the protective layer respectively.

The substrate 110A and the substrate 110B may be rigid or stiff substrates. The materials of the substrate 110A and the substrate 110B include, for example, metal, glass, plastic, etc., but the disclosure is not limited thereto. The metal may include iron, aluminum, copper, or other suitable metal materials, and when the metal or the glass is used to make the substrate, a thickness of the substrate may be between 0 mm and 0.5 mm such as 0.15 mm, 0.2 mm, or 0.3 mm for easy storage (bending), but the disclosure is not limited thereto. The plastic may include polycarbonate (PC), polyimide (PI), polypropylene (PP), polyethylene terephthalate (PET), and other suitable flexible materials, or a combination of the aforementioned materials, but the disclosure is not limited thereto. In addition, the light transmittance of the substrate 110 is not limited, that is, the substrate 110A and the substrate 110B may be a light-transmitting substrate, a semi-light-transmitting substrate, or a non-light-transmitting substrate. When the substrate 110A is a non-light-transmitting substrate, the optical film 120 is, for example, disposed on the light-facing side of the substrate 110A. When the substrate 110A is a light-transmitting substrate or a semi-light-transmitting substrate, the optical film 120 may be disposed on the light-facing side or the backlight side (the side opposite to the light-facing side) of the substrate 110A.

Since the substrate 110A and/or the substrate 110B of the partition 100 is a rigid or stiff substrate, when the vehicle 1 is traveling, it is less likely to shake or bend than materials such as curtains. Therefore, when the passenger 7 views a display light beam IB′ reflected from the partition 100, the image information presented is less likely to be distorted or deformed, which can reduce the dizziness or discomfort of the passenger 7 and greatly improve the viewing experience of the passenger 7. On the other hand, through the design in which the optical film 120 is attached or coated onto the substrate 110A and/or the substrate 110B and/or the design in which the optical film 120 is disposed between the substrate 110A and the substrate 110B, even if the substrate 110A and/or the substrate 110B is broken due to an accident, the optical film 120 can adhere to the debris of the substrate 110A and/or the substrate 110B, thereby preventing damage to the passenger 7 or the driver 6 and further ensuring safety and reliability. Furthermore, if the substrate 110A or the substrate 110B is made of the metal material, the thin metal is not easily broken when subjected to external impact, and the optical film 120 formed on the thin metal can reduce the risk of the thin metal cutting the passenger 7 or the driver 6.

In some embodiments, the optical film 120 may be a polarization beam splitting film or a reflective polarizing film, which has different reflectivity and refractive index for incident light of different polarization states. In detail, the optical film 120 has a reflection axial direction RA and a transmission axial direction TA. The transmission axial direction TA is perpendicular to the reflection axial direction RA. The incident light has a first reflectivity and a first transmittance in the reflection axial direction RA, and the incident light has a second reflectivity and a second transmittance in the transmission axial direction TA. The first reflectivity is greater than the second reflectivity. The first reflectivity is, for example, between 20% and 100%. For example, the first reflectivity may be 30%, 40%, 50%, 60%, or 70%. The first transmittance is, for example, between 0% and 80%. For example, the first transmittance may be 20%, 40%, or 60%. The second reflectivity is, for example, between 0% and 40%. For example, the second reflectivity may be 10%, 20%, or 30%. The second transmittance may be between 60% and 100%. For example, the second transmittance may be 70%, 80%, or 90%. However, the disclosure is not limited thereto.

In detail, as shown in FIG. 3, the reflection axial direction RA of the optical film 120 is, for example, parallel to a polarization direction of P-type polarized light P (referring to the double arrows of FIG. 3, the polarization direction of the P-type polarized light P is parallel to a plane formed by the incident light and the reflected light). When the incident light is the P-type polarized light, the optical film 120 has the first reflectivity and the first transmittance for the incident light (P-type polarized light P). On the other hand, the transmission axial direction TA of the optical film 120 is, for example, parallel to a polarization direction of S-type polarized light S (referring to the dots of FIG. 3, the polarization direction of the S-type polarized light S is perpendicular to the plane formed by the incident light and the reflected light). When the incident light is the S-type polarized light S, the optical film 120 has the second reflectivity and the second transmittance for the incident light (S-type polarized light S). Under the design that the first reflectivity is greater than the second reflectivity and the first transmittance is less than the second transmittance, the reflectivity of the optical film 120 for the P-type polarized light P (i.e., the first reflectivity) is greater than the reflectivity of the optical film 120 for the S-type polarized light S (i.e., the second reflectivity), and the transmittance of the optical film 120 for the P-type polarized light P (i.e., the first transmittance) is less than the transmittance of the optical film 120 for the S-type polarized light S (i.e., the second transmittance). That is to say, when the incident light includes the P-type polarized light P and the S-type polarized light S (that is, when both the P-type polarized light P and the S-type polarized light S are incident on the optical film 120), the P-type polarized light P reflected by the optical film 120 will be more than the S-type polarized light S reflected by the optical film 120, and the S-type polarized light S penetrating the optical film 120 will be more than the P-type polarized light P penetrating the optical film 120. That is to say, the P-type polarized light P incident on the optical film 120 will be mostly reflected by the optical film 120 and a small part will penetrate the optical film 120, while the S-type polarized light S incident on the optical film 120 will mostly penetrate the optical film 120 and a small part will be reflected by the optical film 120.

In some embodiments, the polarization direction of the display light beam IB may be parallel to the reflection axial direction RA, so that an intensity of the display light beam IB′ reflected by the partition 100 may be higher, and an intensity of a display light beam IB″ penetrating the partition 100 may be lower. For example, when an intensity of the display light beam IB is E, the first reflectivity is about 80%, and the first transmittance is about 20%, the intensity of the display light beam IB′ reflected by the partition 100 may be 0.8E, and the intensity of the display light beam IB″ penetrating the partition 100 may be less than 0.2E. That is to say, the partition 100 can reflect a larger part of the incident display light beam IB to the human eye. Therefore, the display image formed by the display light beam IB′ viewed by the passenger 7 can have a higher brightness, that is, a clearer display image. Under the design that the partition 100 is light-transmitting, since the intensity of the display light beam IB″ penetrating the partition 100 may be effectively reduced, the image formed by the display light beam IB″ irradiating the windshield 12 in front of the front seat 2 is less obvious, making the driver 6 less susceptible to the influence of the display light beam IB″ that penetrates the partition 100 when viewing the road conditions ahead, so that the driving safety of the driver 6 can also be taken into consideration while considering the viewing experience of the passenger 7.

Since most of the reflected light from the environment is the S-type polarized light, when an ambient light beam EB is incident on the partition 100, an intensity of an ambient light beam EB′ reflected by the partition 100 may be lower, while an intensity of an ambient light beam EB″ that penetrates the partition 100 may be higher. For example, when the intensity of an ambient light beam IB is E, the second reflectivity is about 40%, and the first transmittance is about 60%, the intensity of the ambient light beam EB′ reflected by the partition 100 may be 0.4E, and the intensity of the ambient light beam EB″ penetrating the partition 100 may be less than 0.6E. That is to say, the partition 100 can reduce a smaller part of the ambient light beam EB′ reflected by the partition 100 from being reflected to the human eye. Therefore, when viewing the display image formed by the display light beam IB′, the passenger 7 is less affected by the ambient light beam EB′, which is beneficial to improving the image quality of the image viewed by the passenger 7. When the driver 6 in the front seat 2 needs to view the environment image from the rear through the rear windshield (for example, the road condition image behind the vehicle 1), the higher transmittance (such as the second transmittance) design of the partition 100 for the ambient light beam IB makes the ambient light beam EB″ also have sufficient brightness, which also helps the driver 6 view the road conditions (such as rear vehicles) or the passenger 7 from behind, allowing the driver 6 to control driving safety.

In some embodiments, in order to maintain the stability of the partition 100 or reduce the shaking of the partition 100 while the vehicle 1 is traveling, the projection module 10A may further include a fixing module 130A to fix the partition 100. For example, the fixing module 130A may include a first fixing member 131 and a second fixing member 132. The first fixing member 131 may be disposed on a vehicle roof 5 for connecting a first side of the partition 100 (for example, a side close to the vehicle roof 5 in the direction Z), but the disclosure is not limited thereto. In some embodiments, for example, the first fixing member 131 may be disposed on the vehicle pillar 4 of the vehicle 1. On the other hand, the second fixing member 132 may be disposed on a side of the front seat 2 facing the rear seats (including the rear seat 3A and the rear seat 3B) and connected to a second side of the partition 100 (for example, another side opposite to the aforementioned side in the direction Z). In some embodiments, as shown in FIG. 2, the amount of the second fixing member 132 may be plural (e.g., two). The two second fixing members 132 may be disposed on two opposite vehicle pillars 4 of the vehicle 1 in the direction X. By fixing the partition 100 through the above-mentioned fixing module 130A, the displacement of the partition 100 caused by braking, acceleration, or bumps may be reduced. In addition, with the stiff material of the partition 100, the light-facing surface of the partition 100 (in FIG. 2, the light-facing surface is the surface of the partition 100 facing the projection device 200) can remain stable, greatly improving the comfort level for the passenger 7 when viewing the display image on the partition 100.

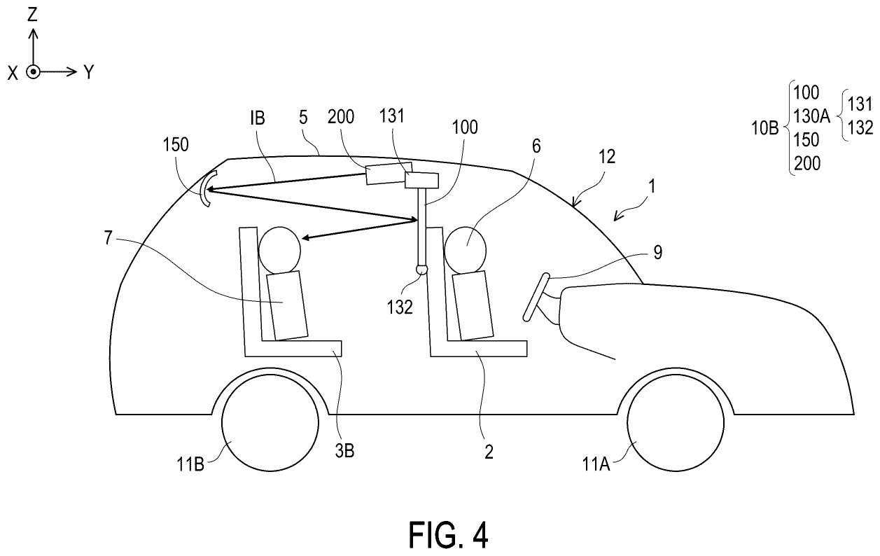

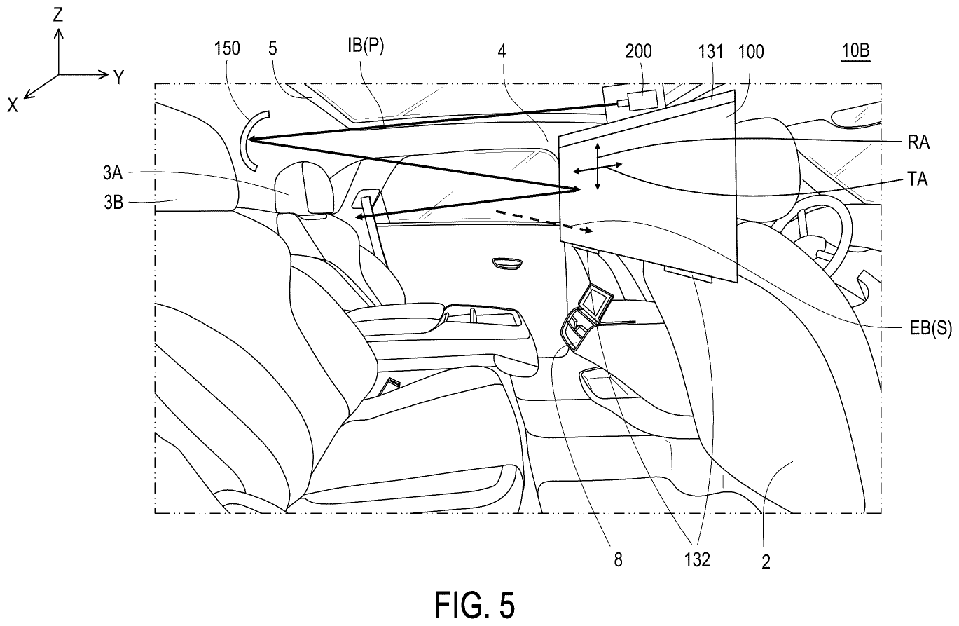

Referring to FIG. 4 and FIG. 5, the main differences between a projection module 10B and the projection module 10A of FIG. 1 are described below. The projection module 10B also includes a reflector 150. The reflector 150 and the rear seats (including the rear seat 3A and the rear seat 3B) are located on the same side of the partition 100. For example, in the direction Y, the reflector 150, the rear seat 3A and the rear seat 3B are all disposed opposite to the partition 100. In addition, the projection device 200 is located between the front seat 2 and the rear seats (including the rear seat 3A and the rear seat 3B). For example, the projection device 200 may be disposed on the partition 100. The display light beam IB from the projection device 200 may be transmitted to the partition 100 via the reflector 150. For example, the display light beam IB is transmitted from the projection device 200 to the reflector 150, then reflected to the partition 100 via the reflector 150, and finally reflected to the passenger 7 via the partition 100.

The reflector 150 may be a plane mirror or a curved mirror, but the disclosure is not limited thereto. In other embodiments not shown, the reflector 150 may also include a lens assembly or a lens group for expanding or amplifying the display light beam IB, so that after being reflected by the reflector 150, the display light beam IB can illuminate the entire plane of the partition 100 as much as possible, thereby allowing the passenger 7 to watch a larger image to enhance the viewing experience.

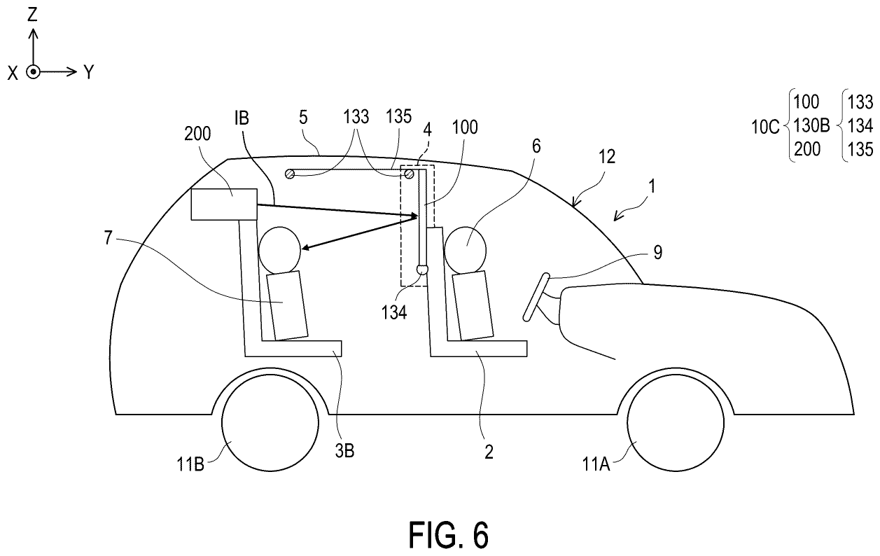

Referring to FIG. 6, the main differences between a projection module 10C and the projection module 10A of FIG. 1 are described below. In the projection module 10C, a fixing module 130B of the projection module 10C includes, for example, a plurality of rollers (such as rollers 133 and 134) and a rope 135. The rollers 133 and 134 are, for example, fixed in the vehicle pillar 4 and the vehicle roof 5. The rope 135 is connected to the rollers 133 and 134. The partition 100 is linked with the rope 135, and the position of the partition 100 may be changed by pulling the rope 135. For example, a plurality of rollers 133 may be fixed in the vehicle roof 5, and a plurality of rollers 134 may be fixed in two opposite vehicle pillars 4 in the direction X. The rope 135 may be hidden in the vehicle pillar 4 and the vehicle roof 5 or partially exposed, so that the passenger 7 can pull the rope 135 manually or electronically (such as through a motor or other actuator not shown) to change the position of the partition 100. The rope 135 may be a telescopic rope or a steel rope used in the projection device, but the disclosure is not limited thereto.

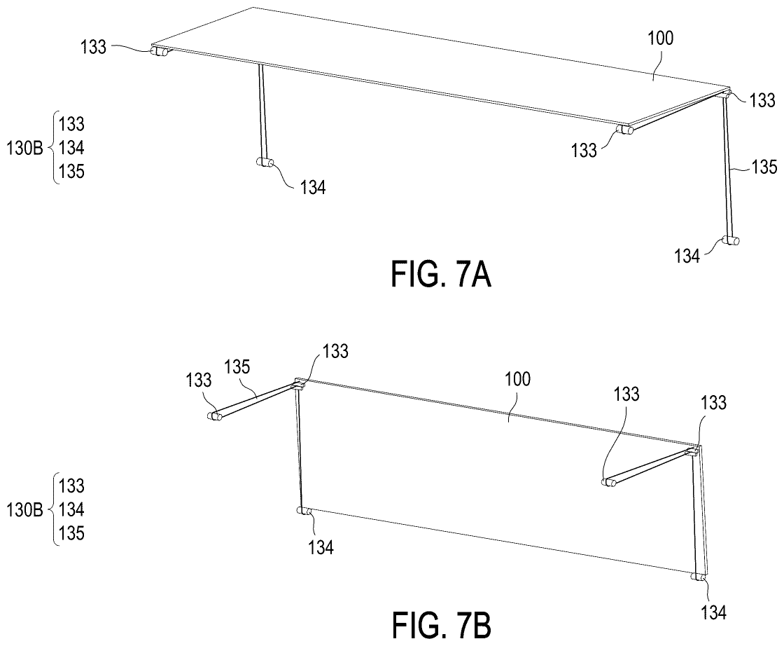

For details, referring to FIG. 7A first, when the projection module 10C is not required to provide the display image, the rope 135 may be used to pull the partition 100, so that the partition 100 is retracted from the position between the front seat 2 and the rear seats 3A and 3B (the position in a use state) to the vehicle roof 5 (the position in the storage state), and the partition 100 may be hidden in the interlayer between the vehicle roof 5 (not shown in FIG. 7A) and the plurality of rollers 133. In this way, the passenger 7 can communicate with the driver 6 more conveniently (such as exchanging items, etc.) without being blocked by the partition 100.

Referring again to FIG. 7B, when the projection module 10C is required to provide the display image, the rope 135 may be used to pull the partition 100 and lower the partition 100 from the vehicle roof 5, so that the partition 100 may be located between the front seat 2 and the rear seats (including the rear seat 3A and the rear seat 3A). In this way, the passenger 7 can clearly view the display image corresponding to the display light beam IB′ through the partition 100. For relevant technical content, please refer to the preceding paragraphs and therefore a detailed description will be omitted.

To sum up, in the projection module of the disclosure, through the optical matching of the partition and the projection device, the display image formed by the display light beam may be made to have sufficient brightness and be less affected by the ambient light, so that it is convenient for the user to watch or does not affect the driver when the projection module is in operation. In addition, the partition formed by the composite of the substrate and the optical film can have both stiffness and safety, which can further maintain the quality of the display image formed by the display light beam and ensure the safety of the user.

The above embodiments are only used to illustrate, but not to limit, the technical solutions of the disclosure. Although the disclosure has been described in detail with reference to the above embodiments, persons skilled in the art should understand that the technical solutions described in the above embodiments can still be modified, or some or all of the technical features thereof can be equivalently replaced. However, the modifications or replacements do not cause the essence of the corresponding technical solutions to deviate from the scope of the technical solutions of the embodiments of the disclosure.

Although the embodiments of the disclosure and the advantages thereof have been disclosed above, it should be understood that any person skilled in the art can make changes, substitutions, and modifications without departing from the spirit and scope of the disclosure, and the features of the embodiments can be arbitrarily mixed and replaced to form other new embodiments. In addition, the protection scope of the disclosure is not limited to the process, machine, manufacture, material composition, device, method, and steps in the specific embodiments described in the specification. Any person skilled in the art can understand conventional or future-developed processes, machines, manufactures, material compositions, devices, methods, and steps from the content of the disclosure as long as the same can perform substantially the same functions or achieve substantially the same results in the embodiments described herein. Therefore, the protection scope of the disclosure includes the above processes, machines, manufactures, material compositions, devices, methods, and steps. In addition, each claim constitutes a separate embodiment, and the protection scope of the disclosure further includes combinations of the claims and the embodiments. The protection scope of the disclosure should be defined by the appended claims.

What is claimed is:

1. A projection module used in a vehicle, wherein the vehicle comprises a front seat and a rear seat, the projection module comprising:
a partition, disposed between the front seat and the rear seat, and comprising a substrate and an optical film disposed on the substrate, wherein the optical film has a reflection axial direction and a transmission axial direction, incident light has a first reflectivity and a first transmittance in the reflection axial direction, and the incident light has a second reflectivity and a second transmittance in the transmission axial direction; and
a projection device, configured to project a display light beam to the optical film of the partition,
wherein the first reflectivity is greater than the second reflectivity;
the first reflectivity is between 20% and 100%;
the first transmittance is between 0% and 80%;
the second reflectivity is between 0% and 40%; and
the second transmittance is between 60% and 100%.

2. The projection module according to claim 1, wherein the vehicle further comprises a vehicle roof located above the rear seat and a vehicle pillar between the front seat and the rear seat, the projection module also comprising:
a plurality of rollers, fixed in the vehicle pillar and the vehicle roof; and
a rope, connected to the plurality of rollers, wherein the partition is linked to the rope, and a position of the partition is changed by pulling the rope.

3. The projection module according to claim 1, the projection module further comprising:
a first fixing member, disposed on a vehicle roof of the vehicle, and configured to connect a first side of the partition; and
a second fixing member, disposed on a side of the front seat facing the rear seat, and connected to a second side of the partition, wherein the first side is opposite to the second side.

4. The projection module according to claim 1, wherein the projection device and the rear seat are located on a same side of the partition.

5. The projection module according to claim 1, further comprising a reflector, wherein the reflector and the rear seat are located on a same side of the partition, the projection device is located between the front seat and the rear seat, and the display light beam is transmitted to the partition via the reflector.

6. The projection module according to claim 1, wherein the partition further comprises another substrate, and the optical film is located between the substrate and the another substrate.

7. The projection module according to claim 1, wherein the substrate is made of metal, glass, or plastic.

8. The projection module according to claim 1, wherein the optical film is coated or attached onto the substrate.

9. The projection module according to claim 1, wherein a polarization direction of the display light beam is parallel to the reflection axial direction.

10. The projection module according to claim 1, wherein the reflection axial direction is parallel to a polarization direction of P-type polarized light, and the transmission axial direction is parallel to a polarization direction of S-type polarized light.

11. The projection module according to claim 2, further comprising a brake, wherein the brake is connected to the rope.

12. The projection module according to claim 2, wherein the projection device is disposed between the vehicle roof and the rear seat.

13. The projection module according to claim 1, wherein the substrate is a light-transmitting substrate or a semi-light-transmitting substrate.

14. The projection module according to claim 3, wherein an amount of the second fixing member is two.

15. The projection module according to claim 14, wherein the two second fixing members are respectively disposed on a side of two front seats facing the rear seat.

16. The projection module according to claim 5, wherein the reflector is a plane mirror or a curved mirror.

17. The projection module according to claim 16, wherein the reflector further comprises a lens group, and the lens group is adapted to expand the display light beam.

18. The projection module according to claim 1, wherein the partition further comprises a protective layer, and the optical film is disposed between the protective layer and the substrate.

19. The projection module according to claim 18, wherein the protective layer is a light-transmitting polymer.

20. The projection module according to claim 18, wherein two opposite sides of the optical film contact the protective layer and the substrate respectively.
